(19) United States
(12) Patent Application Publication
(10) Pub. No.: US 2023/0385840 A1
(43) Pub. Date: Nov. 30, 2023

(54) SYSTEM AND METHOD FOR REDUCING GOVERNMENT IDENTIFICATION FRAUD

(71) Applicant: Capital One Services, LLC, McLean, VA (US)

(72) Inventors: Christopher LANGE, Washington, DC (US); Xinrou LI, Vienna, VA (US); Melissa Yoemans HENG, Glen Allen, VA (US); Hrishikesh Milind KARAMBELKAR, Ashburn, VA (US)

(73) Assignee: Capital One Services, LLC, McLean, VA (US)

(21) Appl. No.: 18/197,478

(22) Filed: May 15, 2023

Related U.S. Application Data
(60) Provisional application No. 63/346,590, filed on May 27, 2022.

(51) Int. Cl. G06Q 20/40; G06Q 50/26; H04L 67/50; G06F 21/31

(52) U.S. Cl. CPC G06Q 20/4016; G06Q 50/265; H04L 67/535; G06F 21/316

(57) ABSTRACT

A system and method for preventing government identification-based fraud is disclosed. When a government identification submission session is initiated, several layers of security checks are performed to ensure that the user behind the session is not a fraudster. First, a session check is performed to ensure that the user device has not initiated more than a predetermined number of sessions within a predetermined time. Next, an attempt check is made in order to ensure that the user has not made more than a predetermined number of government identification submission attempts during the current session. Next, a dual-authentication check is performed to ensure that the phone number provided for the dual-authentication has not been used more than a maximum number of times during a recent period of time. And lastly, a general risk assessment is performed to look for any remaining high-risk flags.

### CROSS-REFERENCE TO RELATED APPLICATIONS

The present application claims the benefit of U.S. Appl. No. 63/346,590, filed May 27, 2022, which is hereby incorporated by reference herein in its entirety.

### TECHNICAL FIELD

Embodiments of the present disclosure are related to fraud prevention, and specifically to detecting and reducing fraudulent operations and/or transactions involving the use of government-issued identifications.

### BACKGROUND

Many banking and other transactions require a mechanism for verifying the user's identity. Often, this is carried out by the user submitting a government identification purporting to belong to them. However, government identifications are not safe from duplication or fraudulent generation. As a result, bad actors can use fake or fraudulent forms of government identification in order to bypass government identification verification mechanisms.

### BRIEF DESCRIPTION OF THE DRAWINGS/FIGURES

The accompanying drawings are incorporated herein and form a part of the specification.

FIG. 1 illustrates a block diagram of example fraud reduction environment according to various embodiments.

FIG. 2 illustrates a block diagram of an example fraud reduction system according to various embodiments.

FIG. 3A illustrates an example user interface according to various embodiments.

FIG. 3B illustrates an example user interface according to various embodiments.

FIG. 4 illustrates a flowchart diagram of an example method for reducing government identification-based fraud according to various embodiments.

FIG. 5 illustrates a process flow diagram of an example method for reducing government identification-based fraud according to various embodiments.

FIG. 6 illustrates an example computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for providing reducing government-identification based fraud and/or fraudulent transactions.

Many modern-day transactions, such as creating a banking or financial account, opening a credit card, or registering with a website, for example, require the user to provide proof of their identity. Often, this requirement of proof mandates that the user provide the system with a known form of picture identification. In this manner, the system is able to review and verify the identification. Government-issued identifications are commonly employed for identity verification purposes since they have well-defined configurations, and the information contained therein can be easily verified against state or other government records. Although the following disclosure is provided with respect to government-issued forms of identification, it should be understood that the concepts and techniques described herein are applicable to any types of identification, whether issued by a government body or not.

However, bad actors and fraudsters have identified ways to counterfeit or spoof government identifications to fool verification systems. For example, in an age of identity theft, personal information can be obtained online and used to generate a near-perfect counterfeit government identification. By feeding this counterfeit government identification into a verification system, the verification system may mistakenly approve the authentication. As a result, the fraudster may erroneously gain access to undeserved accounts, lines of credit, or other valuable data.

Therefore, a system for detecting fraudulent government identification-based transactions is presented herein, according to various embodiments. Because of the sophistication of fraudsters and their ability to generate near perfect counterfeits, such a system is capable of detecting the fraud regardless of the information included in the identification and/or the quality of the counterfeit.

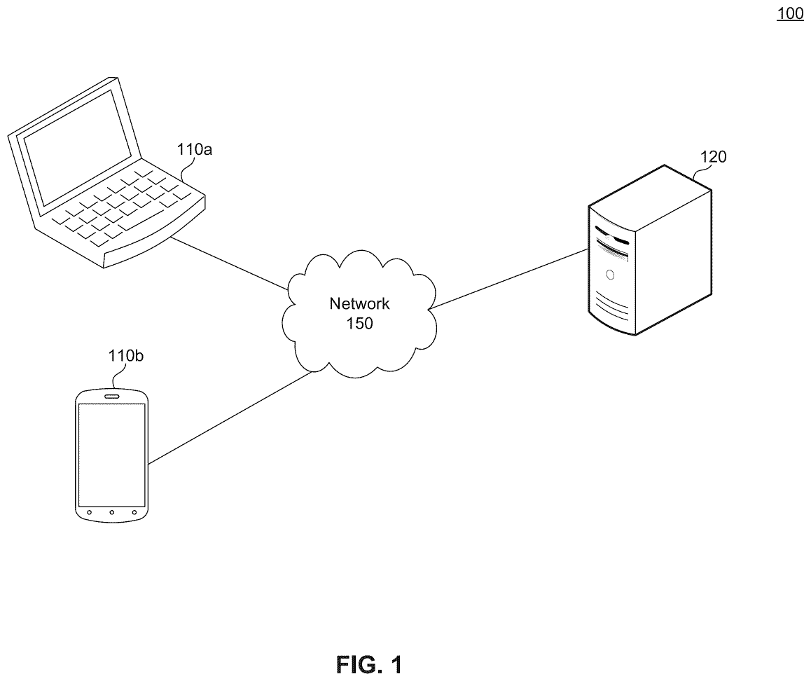

FIG. 1 illustrates a block diagram of example fraud reduction environment 100 according to various embodiments. In one example, environment 100 comprises a user device 110a or 110b (collectively referred to as 110), a network 150, and a merchant server 120.

For illustrative purposes only, user device 110 is illustrated in the form of a laptop computer 110a or in the form of cellular phone 110b. However, a person of skill in the art will recognize that user device 110 may be one of any number of user devices, such as a computing device, a smart device, a mobile device, and/or the link. In embodiments, user device 110 accesses the merchant server 120 over the network 150. In embodiments, the network is any network capable of effecting communication between the user device 100a/b and the merchant server 120, and may be a LAN, WAN, PAN, VPN, or other network and may include the Internet. In embodiments, the merchant server 120 may include any number of servers, computers, and/or databases for carrying out the functionality described herein.

As discussed above, the user may access the merchant server 120 for a variety of different reasons, such as to browse a merchant website, access existing account information, submit feedback, request a particular service, or others. However, certain actions are not simply permitted based on basic website access, but rather trigger the government identification verification procedure. Such actions, as described above, may include account generation, transfer of funds, request for services, opening or increase of credit line, etc.

Regardless of the reason, when an action causes the merchant server 120 to trigger the government identification verification procedure, the merchant server first determines whether to initiate a verification session with the user at all. This initial determination constitutes a first fraud reduction mechanism for reducing government identification based fraud.

For example, when a user accesses the merchant server 120, the merchant server 120 may obtain several pieces of metadata relating to the user device 110. Such metadata may include, for example, data made available to the merchant server 120 for purposes of formatting the user interface and other communication data, and may include, for example and without limitation, IP address, screen size, screen resolution, country of origin, font, language, etc. Based on these, the merchant server 120 may perform a fingerprinting process to uniquely identify the user device. In embodiments, the fingerprinting process is performed by a third party. Based on the fingerprinting operation, a unique identifier is assigned to the user device. Using this identifier, the merchant server 120 may access a database (local or remote) that stores user activity data and determine a number of times the same user device has requested a verification session. Based on this, the merchant server 120 makes a determination of whether to allow the user to initiate a new verification session. This first fraud reduction mechanism is described in further detail below. Another fraud reduction mechanism addresses potential brute force attacks.

Fraudsters often employ brute force techniques in order to attempt to defraud the system. Brute force is a trial-by-error technique in which several attempts might be rejected by the government identification system. The user refines the identification or provides a new identification in response to each failed attempt until one succeeds.

To address brute force fraud, the merchant sever 120 stores each attempt in a database of user activity. The merchant server 120 then checks the database to ensure that the user has not already made a maximum number of government identification submissions. In an embodiment, this occurs prior to the merchant server 120 initiating the verification session, and is based on device fingerprint described above. In another embodiment, this second fraud reduction mechanism is performed after the verification session has been initiated, and is based on the number of submissions in that session. This type of fraud reduction mechanism is useful to address brute force techniques.

Once the session has been established, the merchant server 120 notifies the user that a government identification submission is required, and requests that the user submit a government identification image captured on their user device 110. In an embodiment, the merchant server 120 requires that the user capture the government identification image using a device camera, such as a cellular phone camera. In other embodiments, when the user device is not capable of capturing and/or transmitting a photograph, the user may be directed to use a device having these capabilities. In an embodiment, the merchant server 120 performs the brute force fraud reduction method, as described above, and then analyzes the government identification image for authenticity. According to embodiments, this analysis may include image analysis, optical character recognition (OCR), comparing extracted information to information included in one or more databases, etc. In an embodiment, this analysis is performed by a third party and the merchant server 120 merely transmits the necessary data to the third party for analysis and receives a reply from the third party with the results of the analysis.

Based on the results of the government identification analysis, the merchant server 120 either grants or declines the user's access or authentication request. Specifically, if the analysis shows the government identification to be authentic and accurate, then the user's request is granted. Otherwise, the user's request is denied.

In some embodiments, rather than outright authorizing or denying the user's request, the merchant server 120 may require multi-factor authentication. Multi-factor authentication is an electronic authentication method in which a user is granted access only after successfully presenting two or more pieces of evidence to an authentication mechanism. In an embodiment, multi-factor authentication is required for all government identification submissions.

Therefore, in an embodiment, the merchant server 120 also sends a message, such as an SMS text message, to the user. To do this, the merchant server 120 first must identify a phone number to which to send the message. This can be obtained, for example, by requesting a contact number from the user, by retrieving a telephone number associated with the user from a database, by retrieving the telephone number through an associated telephone app, etc. Using this telephone number, the merchant server 120 performs yet another fraud reduction mechanism. In an embodiment, other contact methods can be used, such as a phone call, an email notification, an iMessage, a P2P message, or other communication method.

Fraudsters often carry out multiple government identification attempts over several different sessions, and using several different user devices (e.g., such as different laptops). However, a fraudster will often use one or only a few different phone or SMS numbers for two-factor authentication purposes. As such, the merchant server 120, by accessing data stored in the database relating to phone call or SMS text messages previously sent, the merchant server 120 can identify a potential fraudster. For example, in this fraud reduction mechanism, the merchant server 120 may determine whether a predetermined number of SMS text messages have been sent to the user's phone number within a recent predetermined time. This will be discussed in further detail below.

As a final check, even if all of the other mechanisms have been passed, the merchant server 120 can still perform a general risk assessment. This assessment can include a determination of whether the user's IP address is suspicious, whether the user device is located in a high-risk country, whether there is a malformed device fingerprint, etc.

Only if all the above fraud reduction mechanisms, as well as the risk assessment, are passed is the user's request granted. Otherwise, the user's request is blocked and some remedial action is taken by the merchant server 120. For example, in an embodiment, the user is prevented from verifying their government identification any further, and the user flows to a higher verification requirement. This, as well as the fraud reduction mechanisms discussed above, will be discussed in further detail below with respect to the figures.

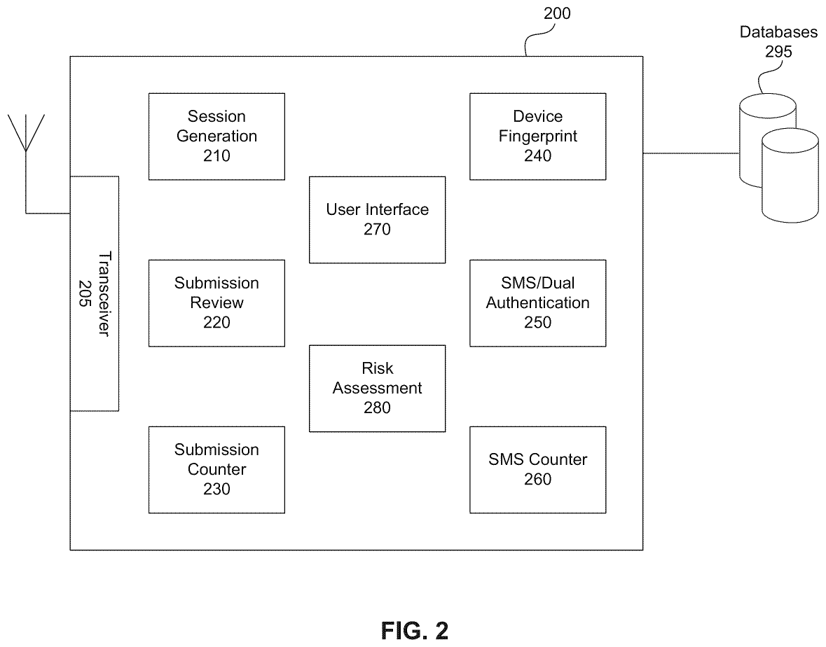

FIG. 2 illustrates a block diagram of an example fraud reduction system according to various embodiments. As shown in FIG. 2, the merchant server 200 includes a transceiver 205, a session generation function 210, a submission review function 220, a submission counter 230, a fingerprint function 240, an SMS-dual authentication function 250, an SMS counter 260, a user interface 270, and risk assessment function 280, and may represent an embodiment of merchant server 120 of FIG. 1. In embodiments, the functions 210, 220, 240, 250, and 280, as well as the user interface 270, are performed by one or more processors and or circuits. In embodiments, the processors are programmed with computer instructions that cause a computer to execute the functions as they are described herein. In embodiments, the counters 230 and 260 correspond to device storage, such as on-board memory. However, in another embodiment, the counters 230 and 260 are stored in a separate one or more databases 295 that store user activity and/or other data.

In some embodiments, the transceiver is configured to communicate electronically with external devices, such as user device 110. The transceiver may receive digital data, including access requests, government identification images, and other data from the user device 110 and transmit user interface, access grants, and other information to the user device 110.

In some embodiments, the user interface 270 is configured to generate the webpages or other user interfaces that are provided to the user. The user may interact with the images and information shown in the user interface in order to progress through the site, submit requests and/or commands, provide government identification images, etc.

When the user first accesses the interface (hereinafter also referred to as website or webpage), the fingerprint function 240 performs a fingerprinting function to uniquely identify the user device 110. In some embodiments, the fingerprint function 240 obtains several pieces of metadata relating to the user device 110, such as IP address, screen size, screen resolution, country of origin, font, language, etc. Using this metadata, the fingerprint function 240 performs a fingerprinting process to uniquely identify the user device. For example, the fingerprinting process may compare the obtained metadata (or data derived therefrom) with previously stored data or expected data. Based on the fingerprinting operation, a unique identifier is assigned to the user device 110 and is stored in the database 295.

While the user navigates the website, the session generation function 210 is configured to monitor the user's actions to determine when an action causes the triggering of the government identification verification procedure. This can occur, for example, when the session generation function 210 detects certain actions by the user, such as the request for the opening of an account, a new credit line, a transfer of funds, etc. In response, the session generation function 210 determines whether to initiate a government ID verification session with the user. This initial determination constitutes a first fraud reduction mechanism for reducing government identification based fraud.

In order to perform this first fraud reduction mechanism, the session generation function 210 uses the device fingerprint of the user device 110 obtained by the fingerprint function 240. The session generation function 210 accesses the database and queries for all recent sessions involving that device fingerprint. In an embodiment, the sessions are retrieved for a predetermined amount of time, such as a 24-hour period ending at a present time or a current day. Based on this information, the session generation function 210 determines whether the user device 110 has initiated more than a predetermined threshold number of sessions. In an embodiment, the threshold number of sessions is five.

If the user device 110 exceeds the predetermined threshold, then the session generation function 210 does not generate the government identification session and causes the user interface function 270 (hereinafter UI) to display an error message to the user. If, on the other hand, the user device 110 has not exceeded the predetermined threshold, then the session generation function 210 generates the government identification verification session to allow the user to submit a government identification. If allowed, the session generation function 210 increments a submission value stored in the database 295.

Once the session has been established, a submission review function 220 performs a second fraud reduction mechanism. Specifically, in order to prevent brute force techniques, submission attempts are stored in a submission counter 230 (or in database 295). Either in response to determining that the government identification verification session is needed, or in response to a government identification submission by the user, the submission review function 220 accesses the database to determine a number of government identification submissions already provided by the user within a predetermined time. In an embodiment where this occurs prior to a new submission, this determination is made based on submissions associated with the device fingerprint and is based on a predetermined time, such as a past hour, past day, etc. If, on the other hand, this function is performed after the session has been initiated, the determination is made based on a number of submissions in the current session.

If the submission review function 220 determines that the user has exceeded a maximum number of government identification submissions within the predetermined time period, then the submission is rejected and the submission review function 220 causes the UI 270 to generate an error page for display to the user. If, on the other hand, the submission review function determines that the user has not exceeded the maximum number of government identification submissions within the predetermined time period, then the user is permitted to submit a government identification image.

In response, the UI 270 generates displays prompting the user to capture an image of a government identification and to submit the image to the system. Upon receipt of the government identification image, the submission review function 220 analyzes the received government identification image using known techniques in order to assess its authenticity and accuracy. At this time, the submission review function 220 also increments a submission counter stored in submission counter 230 or in the database 295. If the submission review function 220 determines that the submission has failed its analysis, then the submission review function 220 causes the UI 270 to notify the user accordingly and request a new submission, provided that the user has not yet reached a maximum number of submissions. If, on the other hand, the submission passes the analysis, then the submission is accepted.

However, in some embodiments, rather than outright accepting (or declining) the user's request, the merchant server 200 may require multi-factor authentication. In this embodiment, an SMS-dual authentication function 250 (hereinafter “SMS function”) sends an SMS text message to the user. To do this, SMS function 250 first acquires a phone number to which to send the SMS text message. This can be obtained, for example, by causing the UI 270 to display a prompt to the user requesting a contact number, by retrieving a telephone number associated with the user from the database 295, by retrieving the telephone number through an associated telephone app, etc. Although the dual authentication is described herein with respect to SMS, as discussed above other types of dual authentication forms may be used such as, but not limited to, a phone call, an email notification, an iMessage, a P2P message, or other communication method.

Using this telephone number, the SMS function 250 performs a third fraud reduction mechanism. Specifically, the SMS function 250 accesses data stored in the database relating to SMS text messages previously sent. This data includes the telephone numbers to which those SMS text messages were sent. Based on this data, the SMS function 250 determines whether a predetermined number of SMS text messages have been sent to the user's phone number within a recent predetermined time. In an embodiment, the predetermined time is a 24-hour period, and a maximum number of SMS text messages is five.

In an embodiment, even if all of the other mechanisms have been passed, a final risk assessment mechanism is performed by risk assessment function 280. In this embodiment, the risk assessment function reviews certain acquired metadata for flags. In an embodiment, the metadata includes the user's IP address, whether the user device is located in a high-risk country, and/or the device fingerprint, etc. If any of these data points raise a flag, such as by the device location being in a high-risk country, or the device's fingerprint being malformed, etc., then the risk assessment function 280 nonetheless denies the user's request.

If each of the above fraud reduction mechanisms are passed, then the user's request is granted. However, if any fail, then the user's request is declined, either outright or pending further authentication measures. In this latter scenario, the UI 270 notifies the user of the rejection and redirects them to a page by which they can provide further authentication data or to a customer service representative. In this manner, the systems and methods herein significantly reduce government identification-based fraud. In some embodiments, each of the fraud reduction mechanisms are performed where appropriate, and a failure of any one of those mechanisms is sufficient to cause a rejection of the user's requested action. However, in other embodiments, the mechanisms are performed sequentially with each acting as a gateway that must be passed before initiating the next. In still further embodiments, a failure of any one of the mechanisms causes the request to be flagged for further scrutiny, but later mechanisms can still be performed, and an aggregated analysis of the different mechanisms is performed prior to authorizing the user's request.

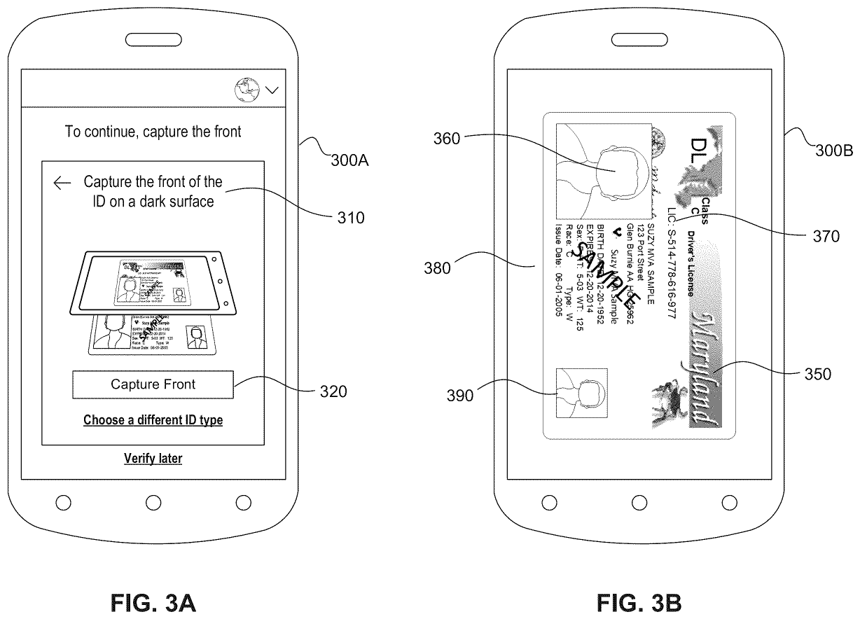

FIG. 3A illustrates an example user interface 300A according to various embodiments. As shown in FIG. 3A, at the appropriate time, the user interface 270 may prompt the user to capture and submit a government identification image. Accordingly, the user interface 300A includes instructions 310 explaining the proper procedure for capturing an image of the government identification. The user interface 300A also includes a capture button 320 that causes the user device 110 to execute the capture operation.

FIG. 3B illustrates an example government identification image 300B according to various embodiments. As shown in FIG. 3B, government identification image 300B includes a state identifier 350 that can be detected by the submission review 220 using either image analysis or optical character recognition, and which is used to assess the authenticity and/or accuracy of the remaining data included in the image. Such information includes, for example, the user image 360, unique identifier 370, and user information 380. In embodiments, the government identification image 300B may also include a security affix 390. The submission review function 220 extracts certain of this information and checks it against one or more databases, such as a state identification database. In some embodiments, the submission review function 220 uses image analysis to verify the presence of all required contents, as well as the proper organization, etc.

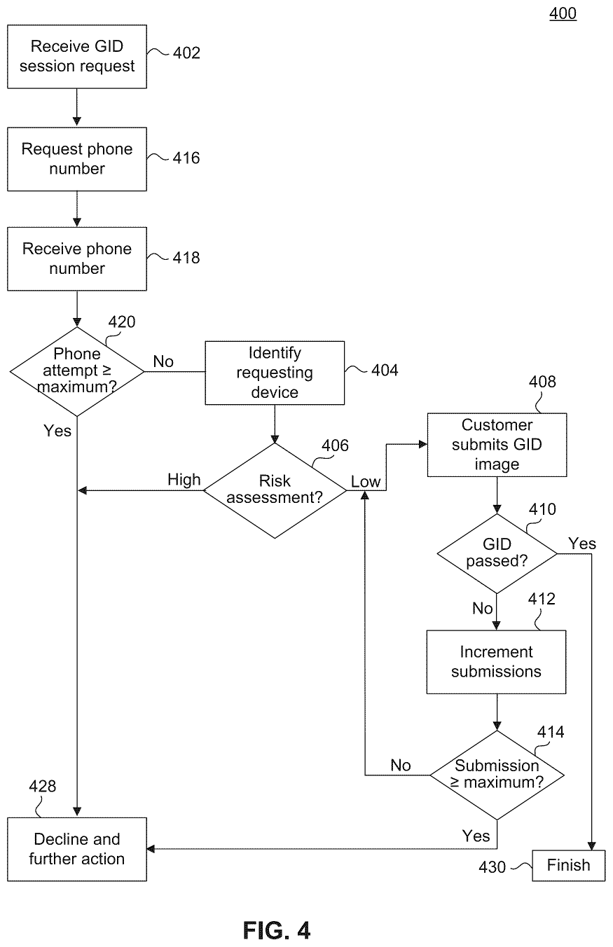

FIG. 4 illustrates a flowchart diagram of an example method 400 for reducing government identification-based fraud according to various embodiments. As shown in FIG. 4, the method begins by receiving a government identification session request 402. In an embodiment, this request can be generated based on the user taking an action that triggers the need for a government identification verification session, as described above.

The method then proceeds to step 416 where the system prompts the user to provide a phone number. In an embodiment, the phone number is acquired through other means, as described above. The method receives the phone number at step 418 and then uses the phone number to perform a maximum attempt check on the phone number. Specifically, the method determines in step 420 whether the phone number has been used a maximum number of times for two-factor authentication within a preceding predetermined time period. If the maximum attempt check fails (420—Yes), then the request is declined in step 428.

On the other hand, if the maximum attempt check succeeds (420—No), then the user device is uniquely identified in step 404. As discussed above, this identification can be based on a fingerprinting algorithm that assigns a unique identifier to the user device based on certain metadata associated with the device. Using the device identifier/fingerprint, a risk assessment is carried out in step 406. In various embodiments, this may include checking a maximum number of government identification verification sessions within a predetermined time. In other embodiments, the risk assessment analysis 406 also or alternatively evaluates certain metadata information for high-risk flags, such as high-risk location, malformed device fingerprint, etc. If the risk assessment in step 406 identifies any high-risk aspects (406—High), then the method proceeds to step 428, where the user request is declined and further action is taken. On the other hand, if no high-risk aspects are identified (406—Low), then the user request is granted and the method proceeds to step 408.

In step 408, a user interface requests the user to provide the government identification image. Upon receiving the government identification image, analysis is performed on the government identification and a determination is made as to whether the government identification has passed the analysis in step 410. If the government identification has failed the analysis (410—No), a submission count number is incremented in step 412. Then, a determination is made as to whether the user has made a maximum number of submissions during the current session in step 414. In an embodiment, steps 412 and 414 are performed prior to requesting the government identification in step 408.

If the user has made a maximum number of submissions during the current session (414—Yes), then the method proceeds to step 428, where the user request is declined and further action is taken. Alternatively, if the user has not reached a maximum number of submissions (414—No), then the method returns to step 408 to request another government identification submission.

If, on the other hand, the government identification analysis passes (410—Yes), then the user request is granted and the method concludes at step 430.

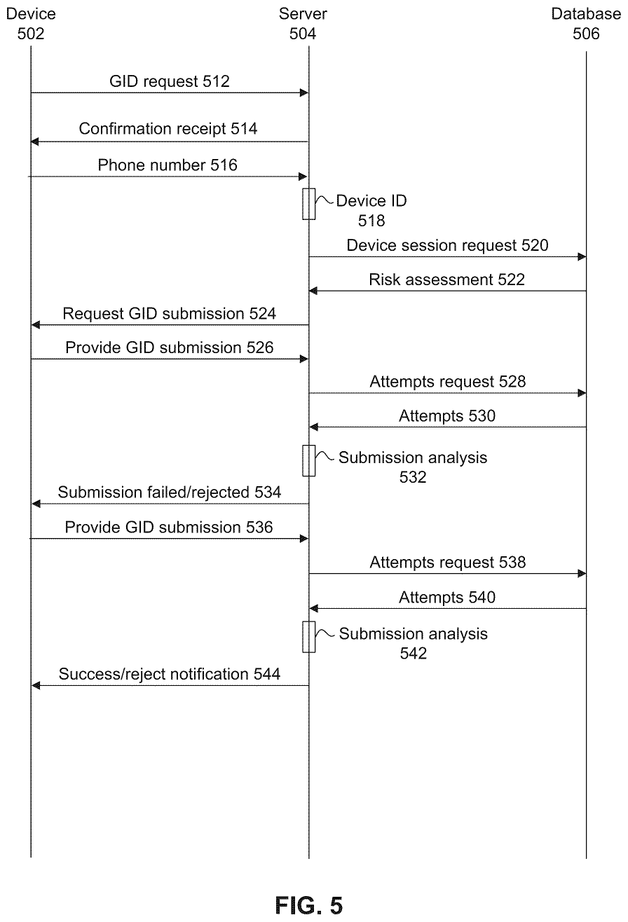

FIG. 5 illustrates a process flow diagram of an example method 500 for reducing government identification-based fraud according to various embodiments. As shown in FIG. 5, the process takes place between a user device 502, a server 504, and a database 506. In an embodiment, the user device 110 is an example embodiment of user device 502, the merchant server 200 is an example embodiment of server 504, and the database 295 is an example embodiment of database 506.

The process begins by the device 502 requesting or triggering a government identification session 512. In response, the server 504 transmits a confirmation receipt message 514 to the device 502. In an embodiment, the confirmation receipt message 514 also requests a phone number from the user of the device 502. In response, the device 502 transmits a phone number 516 to the server 504. In embodiments, the phone number is acquired through other means, such as from the database 506 or an app running on the device 502.

Upon receiving the message or detecting the trigger, the server 504 performs a fingerprinting process 518 in order to assign a unique identifier to the device 502. Based on the unique identifier, the server 504 sends a query 520 to the database 506 for a number of sessions initiated by the device (based on the unique identifier). The database 506 transmits a response 522 with the number of device sessions. If the number of sessions exceeds a maximum, then the server 504 sends a rejection notification 544 to the device 502. In an embodiment, the session maximum check 522 may include a general risk assessment. As discussed above, the risk assessment may include several risk determinations, including evaluating certain metadata information for high-risk flags, such as high-risk location, malformed device fingerprint, etc.

If, however, the number of sessions does not exceed the maximum, then the server 504 sends a request government identification submission message 524 to the device 502. The device responds with the government identification submission 526. The server 504 receives the government identification submission, and then transmits a query 528 to the database 506 requesting a number of submission attempts. In an embodiment, the request is for a number of attempts during a current session. The database 506 transmits a response 530 identifying the number of submission attempts.

Upon receipt, the server 504 performs a submission analysis process 532 to determine whether the number of submission attempts is already at a maximum. If it is, then the process transmits a reject notification 534 to the device 502. If not, then the server transmits a success message 544 to the device 502.

In response to receiving the failed/rejection message 534, the user of the device is prompted to resubmit an image of the user's government identification. The device then transmits the government ID submission 536 to the server 504. Upon receipt of the government ID submission, the server transmits an attempts request 538 to the database to determine whether the user has already exceeded a maximum number of GID submissions. The database 506 transmits a response 540 to the query 536 with either a determination or a number of attempts that have been made by the user.

So long as the number of GID submissions has not yet reached a maximum allowed, then the server 504 performs a submission analysis of the received GID. The GID analysis includes reviewing the GID submission for accuracy and authentication, as discussed above. If all of the above fraud reduction algorithms are passed, then the server 504 transmits a success notification 544 to the device 502 informing the device 502 that the government identification was accepted and that the user's request has been granted.

The methods described above with respect to FIGS. 4 and 5 are merely examples and are not meant to capture all available embodiments. In particular, in both methods, the order of certain processes and checks can be rearranged to suit different needs and/or circumstances. Additionally, more or fewer of those processes can be used in any given system as needed. These and other embodiments will be apparent to a person of skill in the art.

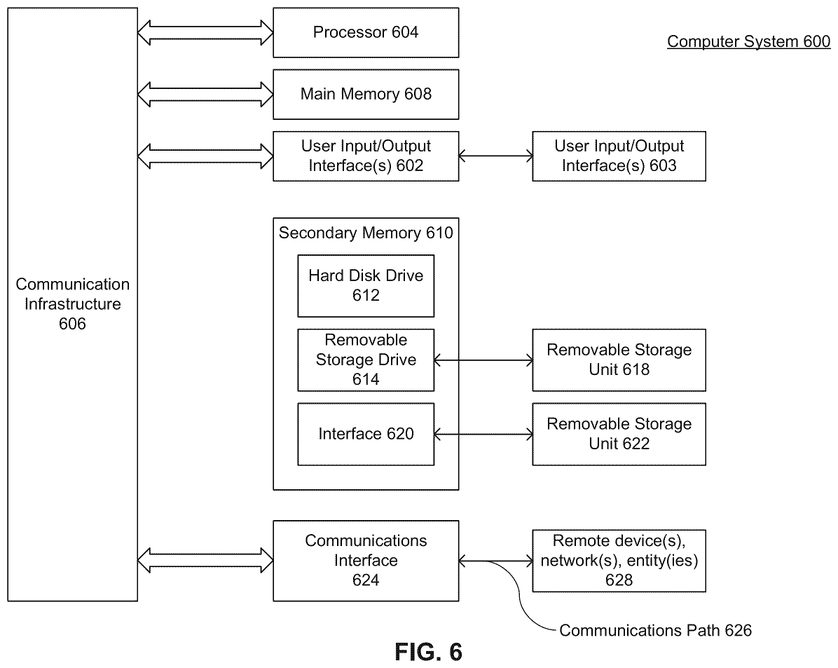

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all example embodiments as contemplated by the inventor(s), and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described example embodiments, but should be defined only in accordance with the following claims and their equivalents.

What is claimed is:

1. A method, comprising:
receiving a request from a user device to initiate a verification session;
performing a first security verification based on a number of verification sessions initiated by the user device;
receiving a government identification submission from the user device in response to the first security verification;
performing a second security verification based on a number of submissions made by the user device;
receiving a contact number associated with the user device in response to the second security verification;
performing a third verification based on a number of verification messages transmitted to the contact number; and
authorizing the request from the user when each of the first, second, and third verifications are passed.

2. The method of claim 1, wherein the first security verification includes receiving, from a database, a number of session requests initiated by the user device within a current time period.

3. The method of claim 2, wherein the first security verification includes determining whether the number of session requests exceeds a maximum number of session requests.

4. The method of claim 1, wherein the second security verification includes receiving, from a database, a number of submission attempts made by the user device within a current session.

5. The method of claim 4, wherein the second security verification further includes determining whether the number of submission attempts exceeds a maximum number of submission attempts.

6. The method of claim 1, wherein the third verification includes receiving, from a database, a number of verification messages transmitted to the contact number within a current time period.

7. The method of claim 6, wherein the third verification further includes determining whether the number of verification messages transmitted to the contact number exceeds a maximum number of submission attempts.

8. A fraud reduction system, comprising:
a transceiver configured to send and receive communications with an external device;
a database that stores user activity data; and
one or more processors configured to:
receive a session request from the external device;
first determine, based on the stored user activity data, whether the external device has exceeded a maximum number of sessions for a first current time period;
receive a government identification submission in response to the determining;
identify, from the user activity data, a number of government identification submissions attempted by the external device within a second current time period;
second determine, based on the identifying, whether the external device has exceeded a maximum number of government identification submission attempts for the second current time period;
analyze the government identification submission; and
authorize or reject the government identification submission in response to the first determining, the second determining, and the analyzing.

9. The system of claim 8, wherein the first current time period includes a predetermined number of hours up to and including a current time.

10. The system of claim 8, wherein the second current time period includes a current session.

11. The system of claim 8, wherein the one or more processors are further configured to reject an operation in response to the first or the second determining failing.

12. The system of claim 11, wherein the operation is an account creation attempt.

13. The system of claim 11, wherein the one or more processors are further configured to:
in response to the rejecting, cause the transceiver to transmit a rejection notification to the external device.

14. The system of claim 13, wherein the rejection notification indicates that further forms of identification verification are required to complete the requested operation.

15. A method, comprising:
receiving a session request from a user device;
performing a first security check relating to the session request in response to the receiving;
in response to the user device passing the first security check, performing a second security check based on the user device;
in response to the user device passing the second security check, receiving a government identification submission from the user device;
analyzing the government identification submission; and
authorize or reject a requested operation based on the analysis.

16. The method of claim 15, wherein the requested operation is an account creation operation.

17. The method of claim 15, wherein the first security check confirms that the user device has not initiated more than a predetermined number of sessions within a predetermined time period.

18. The method of claim 15, wherein the second security check verifies that the user device has not submitted more than a predetermined number of government identification submissions within a predetermined time period.

19. The method of claim 15, further comprising:
initiating a dual-mode authentication procedure in response to the passing of the second security check; and
receiving a contact identifier from the user device in response to the initiating;
performing a third security check based on the contact identifier, the third security check verifying that the contact identifier has not been contacted more than a predetermined number of times within a predetermined time period.

20. The method of claim 15, further comprising:
receiving metadata associated with at least one of the user device or the session; and
in response to the first and second security checks being passed, performing a risk assessment based on the received metadata, the risk assessment identifying one or more high risk factors.
